(19) United States
(12) Patent Application Publication
(10) Pub. No.: US 2026/0016865 A1
(43) Pub. Date: Jan. 15, 2026

(54) FOLDABLE ELECTRONIC DEVICE

(71) Applicant: SYNCMOLD ENTERPRISE CORP., New Taipei City (TW)

(72) Inventors: Ching-Hui Yen, New Taipei City (TW); Chien-Cheng Yeh, New Taipei City (TW); Chun-Hao Huang, New Taipei City (TW)

(21) Appl. No.: 19/208,626

(22) Filed: May 15, 2025

Related U.S. Application Data
(60) Provisional application No. 63/670,373, filed on Jul. 12, 2024.

(30) Foreign Application Priority Data
Mar. 26, 2025 (TW) 114111501

(51) Int. Cl. G06F 1/16

(52) U.S. Cl. CPC G06F 1/1681; G06F 1/1616; G06F 1/1652; G06F 1/1656

(57) ABSTRACT

A foldable electronic device is provided and includes a central base, a pivot module, two wing members, two transmission members, two panel bodies, two drop plates, a synchronization module, an elastic module and a flexible screen. The pivot module is provided on the central base. The wing members are pivoted relative to the central base. The transmission members are connected to the pivot module, the synchronization module and the elastic module. The panel bodies are connected to the wing members and the transmission members. The drop plates are connected to the wing members and the panel bodies. The synchronization module drives the transmission members to reverse synchronously. The elastic module is connected to the pivot module. The flexible screen is provided on the central base, the panel bodies and the drop plates and includes a bendable area.

### CROSS-REFERENCE TO RELATED APPLICATIONS

This application claims the benefit of U.S. Provisional Application Serial No. 63/670,373 filed on July 12, 2024, and the benefit of Taiwan Patent Application Serial No. 114111501 filed on March 26, 2025. The entirety of each Application is incorporated herein by reference.

### BACKGROUND

### 1. Technical Field

The present disclosure relates to a foldable electronic device, and more particularly, to a foldable electronic device with a flexible screen.

### 2. Description of Related Art

Flexible screens have been widely applied in smartphones and tablet computers. If a structure for supporting the flexible screen is not well designed, a bendable area of the flexible screen may be damaged when folded, or the flexible screen may not be completely flattened when unfolded, which may cause troubles to users. Although there are linkage structures to provide a required accommodating space for the bendable area, in order to make the accommodating space large enough, internal components of the existing linkage structure have to move a long distance relatively, which increases an overall thickness of corresponding housings.

### SUMMARY

The present disclosure provides a foldable electronic device, which comprises: a central base including a body portion, at least one first inner arc-shaped slideway and at least one second inner arc-shaped slideway, wherein the first inner arc-shaped slideway and the second inner arc-shaped slideway are formed on the body portion and spaced apart from each other; a pivot module disposed on the central base and including a first shaft and a second shaft connected to the body portion, wherein the first shaft extends along a first axis, and the second shaft extends along a second axis; a first wing member including at least one first inner arc-shaped slider and one first pivot portion, the first inner arc-shaped slider slidably disposed on the first inner arc-shaped slideway, wherein the first wing member is able to pivot relative to the body portion with a first inner virtual axis as a center; a first transmission member sleeved on the first shaft; a first panel body including a first carrying member, the first carrying member having a first pivoting joint and a first straight slide groove, wherein the first pivoting joint pivotally connected to the first pivot portion and jointly defined a first outer virtual axis, so that the first carrying member is able to rotate relative to the first wing member about the first outer virtual axis, and wherein the first transmission member is slidably disposed on the first straight slide groove, so that the first carrying member is able to linearly slide relative to the first transmission member; a first drop plate pivotally carried on the first carrying member and slidably connected to the first wing member; a second wing member including at least one second inner arc-shaped slider and one second pivot portion, the second inner arc-shaped slider slidably disposed on the second inner arc-shaped slideway, wherein the second wing member is able to pivot relative to the body portion with a second inner virtual axis as a center; a second transmission member sleeved on the second shaft; a second panel body including a second carrying member, the second carrying member having a second pivoting joint and a second straight slide groove, wherein the second pivoting joint pivotally connected to the second pivot portion and jointly defined a second outer virtual axis, so that the second carrying member is able to rotate relative to the second wing member about the second outer virtual axis, and wherein the second transmission member is slidably disposed on the second straight slide groove, and the second carrying member is able to linearly slide relative to the second transmission member; a second drop plate pivotally carried on the second carrying member and slidably connected to the second wing member; a synchronization module connected to the first transmission member and the second transmission member, and able to drive the first transmission member and the second transmission member to rotate synchronously and reversely; an elastic module including a pushing member, wherein the pushing member is slidably sleeved on the first shaft and the second shaft, and movably engaged with the first transmission member and the second transmission member; and a flexible screen disposed on the first panel body, the second panel body, the first drop plate, the second drop plate and the central base, and including a bendable area, wherein the first panel body and the second panel body are able to change between an unfolded state and a folded state, wherein when the first panel body and the second panel body are in the unfolded state, the flexible screen is flattened, and the first drop plate, the second drop plate and the central base jointly support the bendable area, and wherein when the first panel body and the second panel body are in the folded state, the bendable area of the flexible screen is bent, and the first drop plate, the second drop plate and the central base jointly define an accommodating space to accommodate the bendable area.

In the aforementioned foldable electronic device, the first drop plate includes a first sliding rod portion, the first wing member further includes at least one first curved slide groove, and the first curved slide groove is located between the first inner arc-shaped slider and the first pivot portion for the first sliding rod portion to be slidably disposed therein, and wherein the second drop plate includes a second sliding rod portion, the second wing member further includes at least one second curved slide groove, and the second curved slide groove is located between the second inner arc-shaped slider and the second pivot portion for the second sliding rod portion to be slidably disposed therein.

In the aforementioned foldable electronic device, the synchronization module includes a first main gear, a second main gear, a first auxiliary gear and a second auxiliary gear, and wherein the first main gear is fixedly connected to the first transmission member and moves together with the first transmission member, the second main gear is fixedly connected to the second transmission member and moves together with the second transmission member, the first auxiliary gear and the second auxiliary gear are reversely rotatably connected to the body portion and meshed with each other, the first auxiliary gear is reversely rotatably engaged with the first main gear, and the second auxiliary gear is reversely rotatably engaged with the second main gear.

In the aforementioned foldable electronic device, the first transmission member includes a first driving cam, the second transmission member includes a second driving cam, the pushing member has a first driven cam and a second driven cam, the first driving cam is slidably sleeved on the first shaft along the first axis and fits with the first driven cam, the second driving cam is slidably sleeved on the second shaft along the second axis and fits with the second driven cam.

In the aforementioned foldable electronic device, the first curved slide groove has a first head end and a first tail end opposite each other, the second curved slide groove has a second head end and a second tail end opposite each other, wherein when in the unfolded state, the first sliding rod portion abuts against the first head end, the second sliding rod portion abuts against the second head end, and wherein when in the folded state, the first sliding rod portion abuts against the first tail end, the second sliding rod portion abuts against the second tail end.

In the aforementioned foldable electronic device, the first curved slide groove and the second curved slide groove have a L-shaped cross section, respectively.

In the aforementioned foldable electronic device, the pivot module includes a fixed base, a first shaft hole and a second shaft hole, and the fixed base has a first wing portion and a second wing portion, wherein the first shaft hole is formed through the first wing portion along the first axis, and the first shaft inserts through the first shaft hole, and wherein the second shaft hole is formed through the second wing portion along the second axis, and the second shaft inserts through the second shaft hole.

In the aforementioned foldable electronic device, the first driven cam is sleeved on the first shaft, and the second driven cam is sleeved on the second shaft, wherein the elastic module further includes a first elastic member and a second elastic member respectively sleeved on the first shaft and the second shaft, two ends of the first elastic member respectively abut against the first wing portion and the first driven cam, and two ends of the second elastic member respectively abut against the second wing portion and the second driven cam, wherein when the first panel body and the second panel body are in a half-folded state between the unfolded state and the folded state, the first driving cam and the second driving cam abut against the first driven cam and the second driven cam, and the first elastic member and the second elastic member are compressed, and wherein when the first carrying member and the second carrying member are in the unfolded state or the folded state, the first elastic member and the second elastic member are released correspondingly.

In the aforementioned foldable electronic device, the elastic module further includes a third elastic member, the pushing member further has a positioning elongate column, the fixed base further has a positioning short column, the third elastic member is sleeved on the positioning elongate column and the positioning short column and respectively abuts against the pushing member and the fixed base, and the third elastic member is located between the first elastic member and the second elastic member.

In the aforementioned foldable electronic device, the first axis, the first inner virtual axis, the first outer virtual axis, the second axis, the second inner virtual axis and the second outer virtual axis are parallel to each other.

The aforementioned foldable electronic device, the central base further includes a housing, the housing covers the body portion, when the first panel body and the second panel body are in the unfolded state, the first drop plate and the second drop plate contact a top side of the housing, when the first panel body and the second panel body are in the folded state, the first drop plate and the second drop plate are away from the housing.

In the aforementioned foldable electronic device, the first straight slide groove extends substantially perpendicular to the first axis, the first transmission member further includes a first bending plate and a first straight slider, the first bending plate bends and extends along a radial direction of the first axis, and the first straight slider extends outward from the first bending plate along the radial direction of the first axis and slides in the first straight slide groove, and wherein the second straight slide groove extends substantially perpendicular to the second axis, the second transmission member further includes a second bending plate and a second straight slider, the second bending plate bends and extends along a radial direction of the second axis, and the second straight slider extends outward from the second bending plate along the radial direction of the second axis and slides in the second straight slide groove.

In the aforementioned foldable electronic device, the first drop plate includes a first outer arc-shaped slider, and the first carrying member further has a first outer arc- shaped slideway, the first outer arc-shaped slider is slidably disposed on the first outer arc- shaped slideway, and wherein the second drop plate includes a second outer arc-shaped slider, the second carrying member further has a second outer arc-shaped slideway, and the second outer arc-shaped slider is slidably disposed on the second outer arc-shaped slideway.

As can be understood from the above, in the foldable electronic device of the present disclosure, the first wing member and the second wing member can pivot relative to the central base, the first carrying member and the second carrying member can pivot relative to the first wing member and the second wing member respectively, the first transmission member and the second transmission member are driven to slide linearly relative to the first carrying member and the second carrying member respectively, and the first transmission member and the second transmission member rotate synchronously and reversely through the synchronization module, so that when the first panel body and the second panel body are in the unfolded state, the first drop plate, the second drop plate and the central base jointly support the bendable area of the flexible screen, when the first panel body and the second panel body are in the folded state, the first drop plate, the second drop plate and the central base jointly define an accommodating space to accommodate the bendable area, so as to effectively create a large enough accommodating space to accommodate the bendable area without increasing the overall thickness.

### BRIEF DESCRIPTION OF THE DRAWINGS

FIG. 1 is a schematic exploded view of a foldable electronic device of the present disclosure in an unfolded state.

FIG. 2is a schematic exploded view of the foldable electronic device of the present disclosure.

FIG. 3 is a schematic exploded view of some components of the foldable electronic device of the present disclosure.

FIG. 4 is a schematic exploded view of some components of the foldable electronic device of the present disclosure from a different viewing angle.

FIG. 5 is a schematic exploded view of some components of the foldable electronic device of the present disclosure from a different viewing angle.

FIG. 6 is a schematic bottom view of a first drop plate and a second drop plate of the foldable electronic device of the present disclosure.

FIG. 7 is a schematic top view of a pivot module, a first transmission member, a second transmission member and an elastic module of the foldable electronic device of the present disclosure in the unfolded state.

FIG. 8is a schematic top view of the pivot module, the first transmission member, the second transmission member and the elastic module of the foldable electronic device of the present disclosure in a half-folded state.

FIG. 9is a schematic top view of the pivot module, the first transmission member, the second transmission member and the elastic module of the foldable electronic device of the present disclosure in a folded state.

FIG. 10 is a schematic cross-sectional view of the foldable electronic device of the present disclosure in the unfolded state.

FIG. 11 is a schematic cross-sectional view of the foldable electronic device of the present disclosure in the folded state.

### DETAILED DESCRIPTION

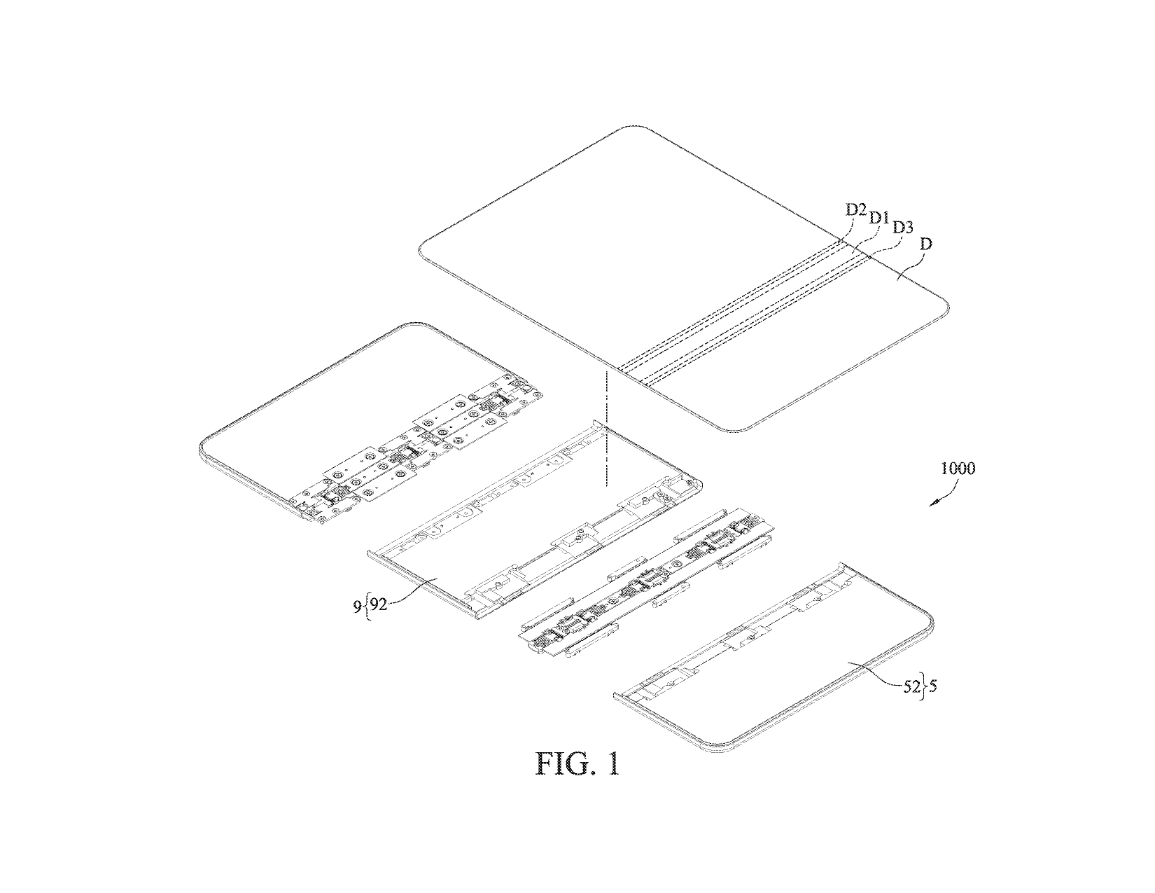

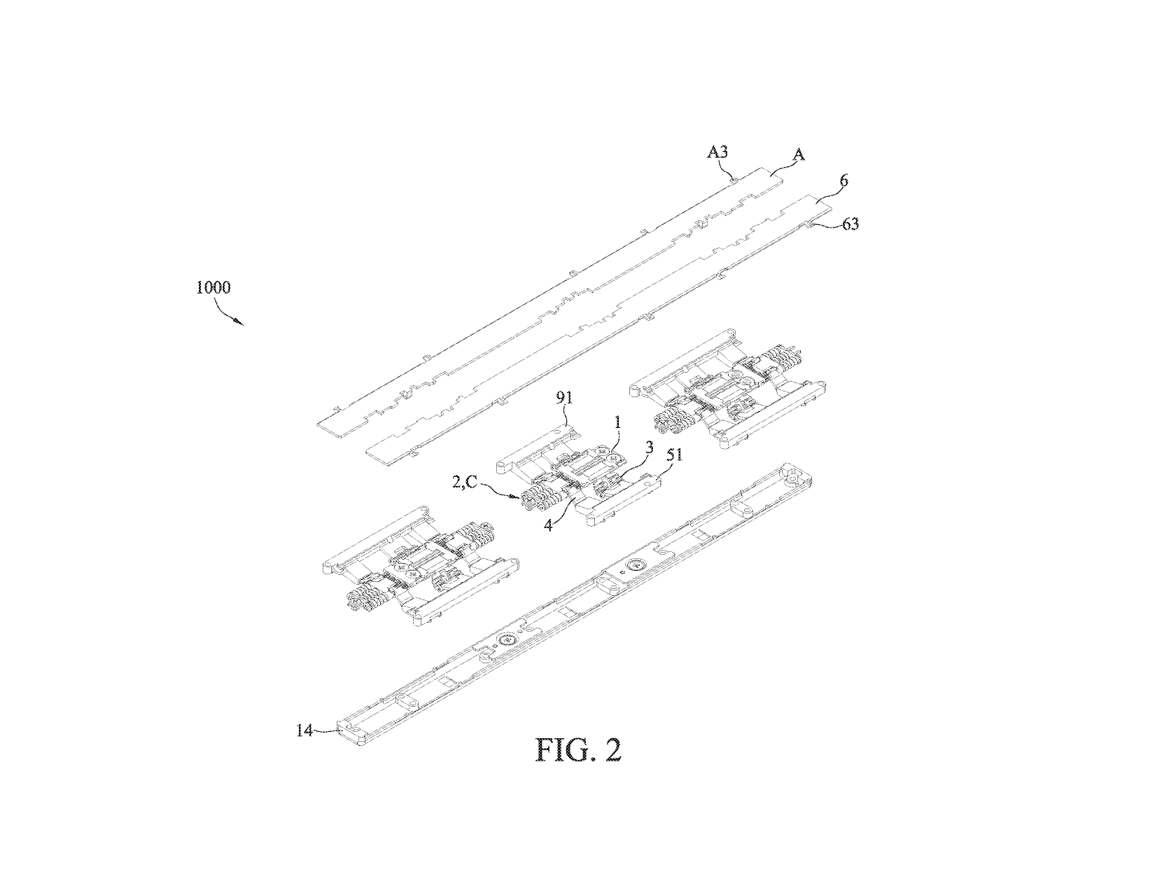

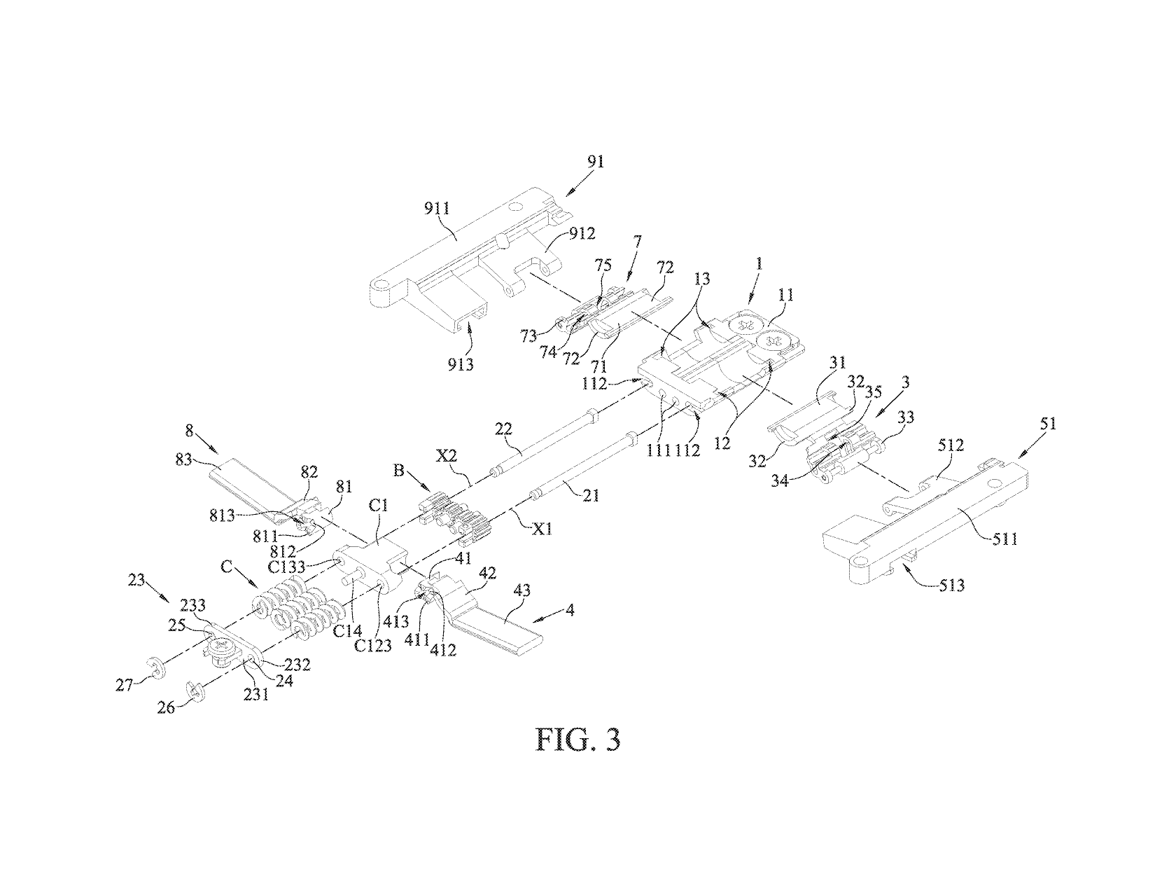

Referring to FIG. 1, a foldable electronic device 1000 of the present disclosure is applied to a double-foldable electronic device for example (that is, it has three panel bodies), but it can also be applied to a single-foldable electronic device. To simplify the description, only the components related to the single-foldable electronic device are described below. Referring to FIG. 2and FIG. 3, the foldable electronic device 1000 of the present disclosure comprises a central base 1, a pivot module 2, a first wing member 3, a first transmission member 4, a first panel body 5, a first drop plate 6, a second wing member 7, a second transmission member 8, a second panel body 9, a second drop plate A, a synchronization module B, an elastic module C and a flexible screen D, wherein the pivot module 2 is disposed on the central base 1, the first wing member 3 and the second wing member 7 are pivotally connected to both sides of the central base 1 respectively, the first transmission member 4 and the second transmission member 8 are respectively connected to the pivot module 2, the synchronization module B and the elastic module C, the first panel body 5 is connected to the first wing member 3 and the first transmission member 4, the first drop plate 6 is connected to the first wing member 3 and the first panel body 5, the second panel body 9 is connected to the second wing member 7 and the second transmission member 8, the second drop plate A is connected to the second wing member 7 and the second panel body 9, the synchronization module B is disposed between the central base 1 and the pivot module 2 and connected to the first transmission member 4 and the second transmission member 8, the elastic module C is disposed on the central base 1 and connected to the pivot module 2, and the flexible screen D is disposed on the central base 1, the first panel body 5, the first drop plate 6, the second panel body 9 and the second drop plate A. The structure of each of the components and the connection relationship between the components will be described in detail below, wherein some figures are drawn with a first inner virtual axis V1, a second inner virtual axis V2, a first outer virtual axis V3, a second outer virtual axis V4, a first axis X1 and a second axis X2 that are parallel to each other. It should be noted that some components in the foldable electronic device 1000 of the present disclosure may be arranged in one set or a plurality of sets, all of which can achieve the operational effect of the present disclosure. The following is a simplified explanation, and only one set is illustrated for example.

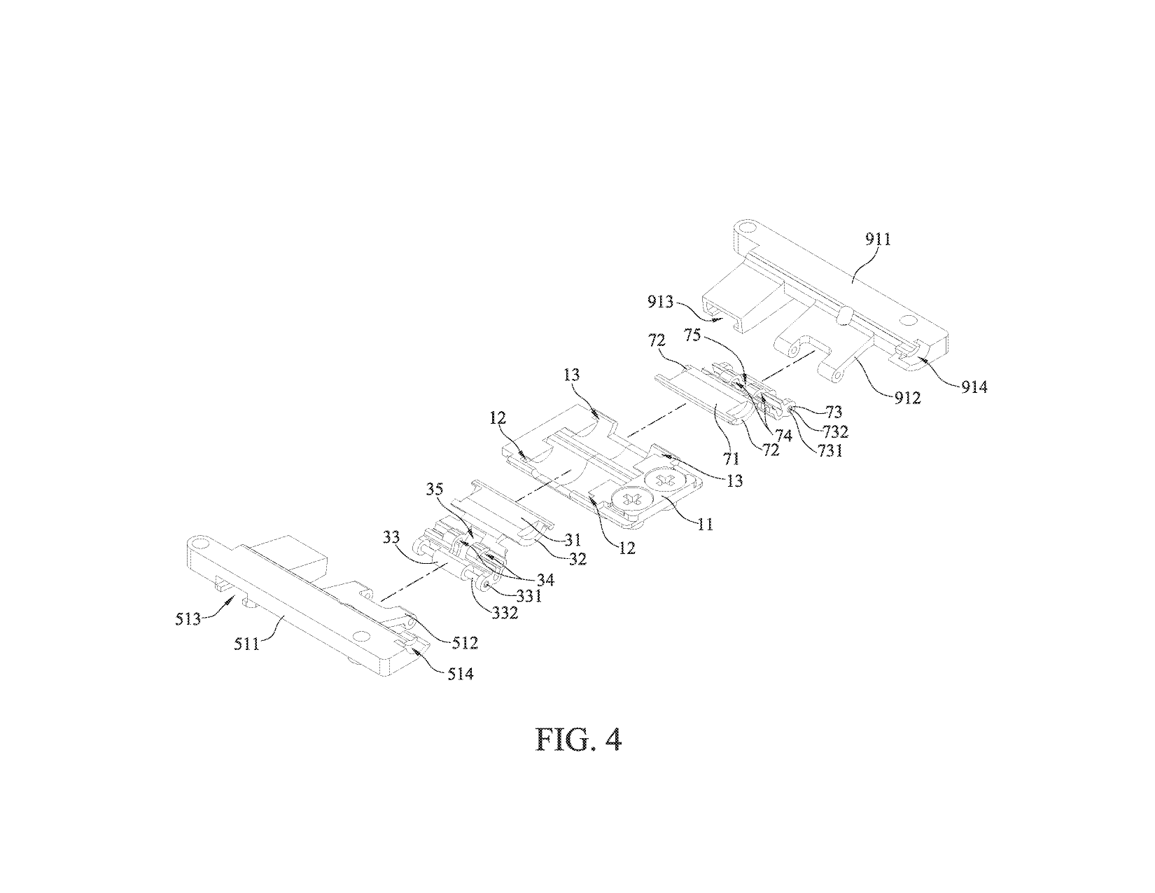

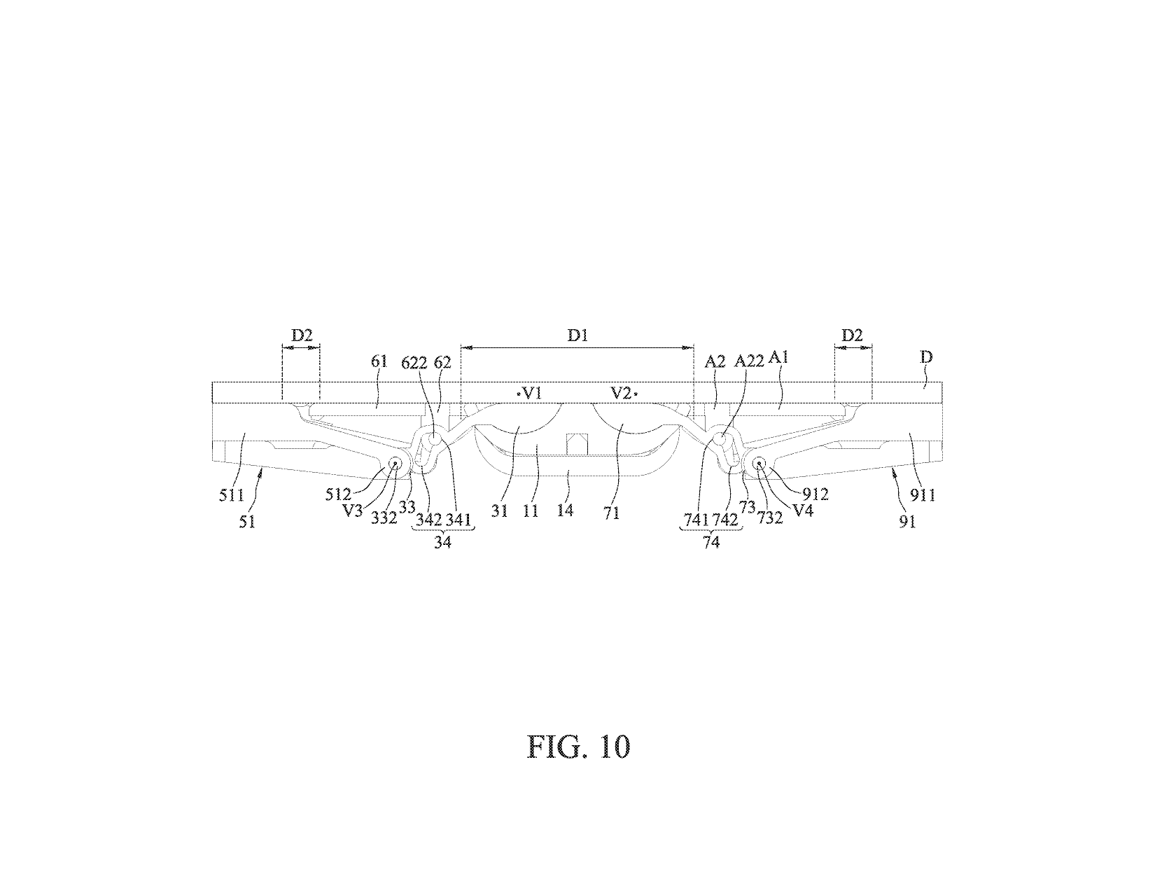

Referring to FIG. 4 at the same time, the central base 1 includes a body portion 11, two first inner arc-shaped slideways 12, two second inner arc-shaped slideways 13 and a housing 14. The body portion 11 has two concave holes 111 and two embedding grooves 112, the concave holes 111 are spaced apart from each other, and the embedding grooves 112 are respectively located outside the concave holes 111. The first inner arc-shaped slideways 12 are recessed and formed on the body portion 11, positioned opposite to each other and spaced apart, and are adjacent to one side of the body portion 11 (i.e., adjacent to the first panel body 5), and their axes are defined as the first inner virtual axis V1 (FIG. 10). The second inner arc-shaped slideways 13 are recessed and formed on the body portion 11, positioned opposite to each other and spaced apart, are adjacent to the other side of the body portion 11 (i.e., adjacent to the second panel body 9), and are spaced apart from the first inner arc-shaped slideways 12, and their axes are defined as the second inner virtual axis V2 (FIG. 10). The housing 14 covers the bottom side and the front side of the body portion 11.

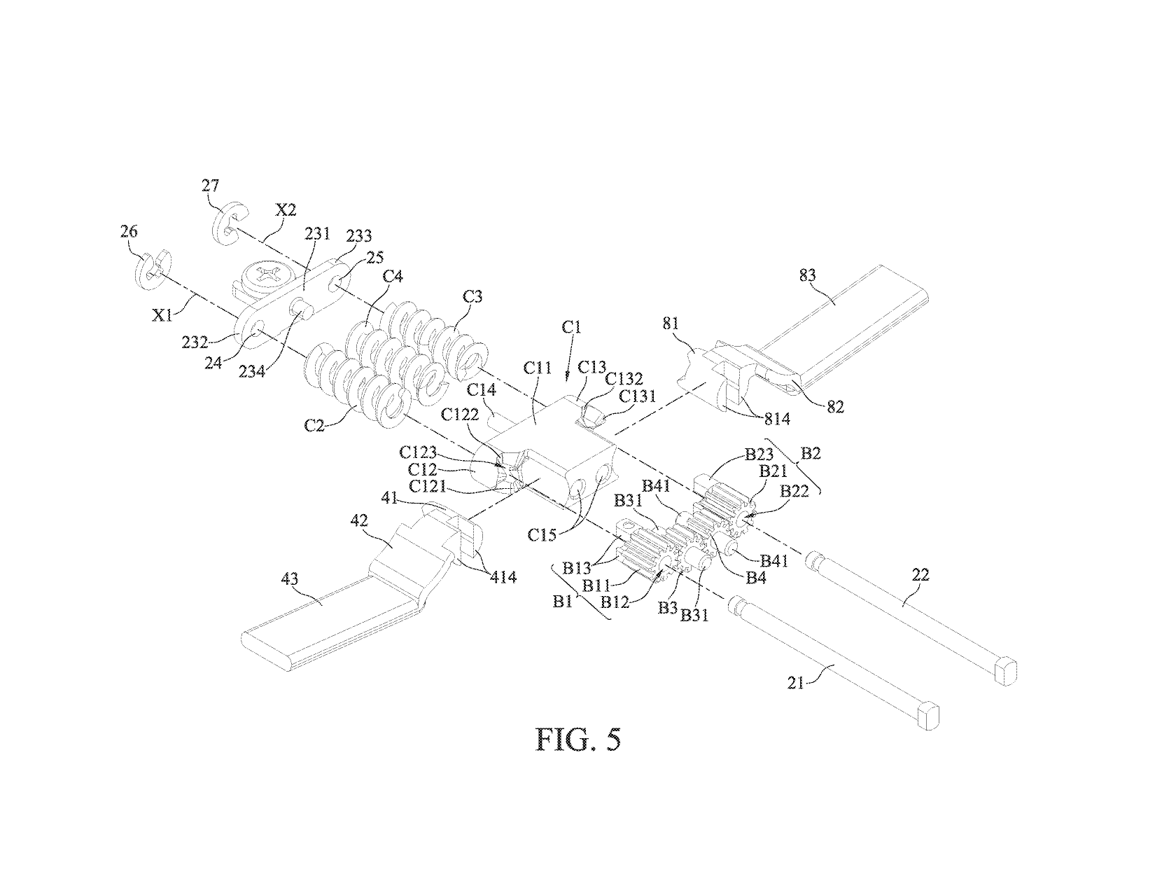

Referring to FIG. 5 at the same time, the pivot module 2 includes a first shaft 21, a second shaft 22, a fixed base 23, a first shaft hole 24, a second shaft hole 25, a first retaining ring 26 and a second retaining ring 27. The first shaft 21 is embedded in one of the embedding grooves 112 along the first axis X1. The second shaft 22 is embedded in the other one of the embedding grooves 112 along the second axis X2. The fixed base 23 has a base body 231, a first wing portion 232, a second wing portion 233 and a positioning short column 234. The base body 231 is disposed on the housing 14 and spaced apart from the body portion 11. The first wing portion 232 and the second wing portion 233 respectively extend outward from opposite sides of the base body 231 and are spaced apart from each other, and the positioning short column 234 is disposed on the base body 231 and is located between the first wing portion 232 and the second wing portion 233. The first shaft hole 24 penetrates the first wing portion 232 along the first axis X1 for the first shaft 21 to insert through and be pivotally connected. The second shaft hole 25 penetrates the second wing portion 233 along the second axis X2 for the second shaft 22 to insert through and be pivotally connected. The first retaining ring 26 is fastened to one end of the first shaft 21 away from the body portion 11, and the second retaining ring 27 is fastened to one end of the second shaft 22 away from the body portion 11.

The first wing member 3 includes a first wing body 31, two first inner arc-shaped sliders 32, a first pivot portion 33, two first curved slide grooves 34 and a first through groove 35. The first wing body 31 is roughly bent in shape. The first inner arc-shaped sliders 32 are roughly semi-arc-shaped bodies, formed spaced apart from each other on one side of the first wing body 31 adjacent to the body portion 11, and are respectively and correspondingly slidably disposed on the first inner arc-shaped slideways 12, thereby the first wing member 3 can pivot relative to the body portion 11 with the first inner virtual axis V1 as the center. The first pivot portion 33 is disposed on one side of the first wing body 31 away from the body portion 11, and has a first pivot portion hole 331 extending along the first outer virtual axis V3 (FIG. 10) and a first pivot portion rod 332 passing through the first pivot portion hole 331. The first curved slide grooves 34 are spaced apart from each other and are respectively surrounded and defined by the first wing body 31, and are located between the first inner arc-shaped slider 32 and the first pivot portion 33, and have an L-shaped cross-section and a first head end 341 and a first tail end 342 opposite to the first head end 341 (FIG. 10). The first through groove 35 is formed through the first wing body 31 and is located between the first inner arc-shaped sliders 32 and the first pivot portion 33, and is located between the first curved slide grooves 34 and communicates with the first curved slide grooves 34.

The first transmission member 4 includes a first driving cam 41, a first bending plate 42 and a first straight slider 43. The first driving cam 41 is an end cam and has three first main convex portions 411, three first main concave portions 412, a first main through hole 413 and two first protrusions 414. The first main convex portions 411 extend outward along the first axis X1 and are spaced apart from each other, and the first main concave portions 412 are respectively formed between any two of the first main convex portions 411 and are spaced apart from each other. The first main through hole 413 is formed through the first axis X1 and is used for the first shaft 21 to insert through. The first protrusions 414 are spaced apart from each other and extend outward along the first axis X1 and face away from the first main convex portions 411. The first bending plate 42 is bent and extends outward along the radial direction of the first axis X1 from the first driving cam 41. The first straight slider 43 extends outward along the radial direction of the first axis X1 from the first bending plate 42, that is, two sides of the first bending plate 42 are respectively connected to the first driving cam 41 and the first straight slider 43.

The first panel body 5 includes a first carrying member 51 and a first panel housing 52. The first carrying member 51 has a first carrying body 511, a first pivoting joint 512, a first straight slide groove 513 and a first outer arc-shaped slideway 514. The first pivoting joint 512 extends outward from the first carrying body 511 and is pivotally connected to the first pivot portion rod 332 of the first pivot portion 33, and the first pivoting joint 512 and the first pivot portion 33 jointly define the first outer virtual axis V3 (FIG. 10), thereby the first carrying member 51 can rotate relative to the first wing member 3 about the first outer virtual axis V3. The first straight slide groove 513 is surrounded and defined by the first carrying body 511, extends roughly perpendicular to the first axis X1, and is used for the first straight slider 43 to slide linearly, thereby the first carrying member 51 can move linearly relative to the first transmission member 4. The first outer arc-shaped slideway 514 is formed on the first carrying body 511 and spaced apart from the first pivoting joint 512. The first panel housing 52, roughly in the shape of quadrilateral, is fixed to the first carrying member 51. In addition, the first panel body 5 further includes electronic components, but they are irrelevant to the folding operation and will not be described again.

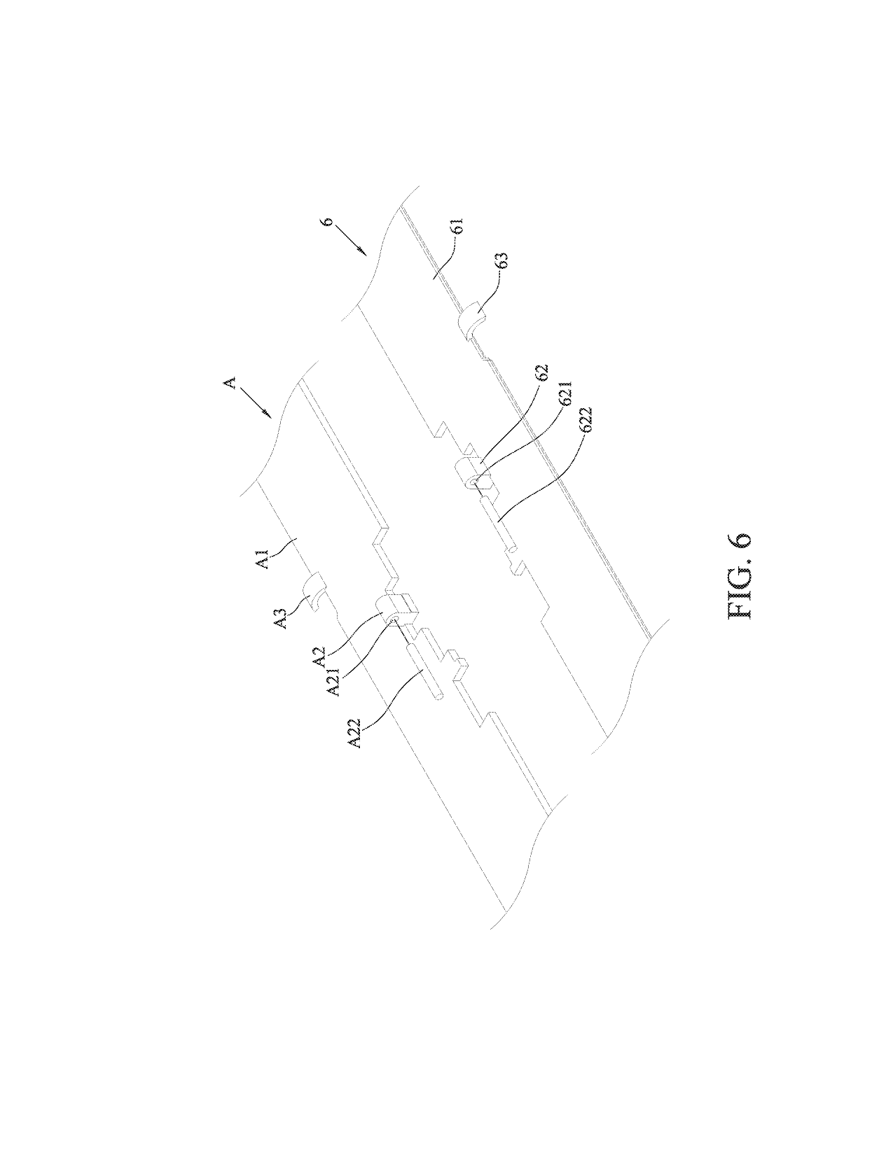

Please refer to FIG. 6, the first drop plate 6 includes a first plate 61, a first sliding rod portion 62 and a first outer arc-shaped slider 63. The first plate 61 is roughly rectangular in shape. The first sliding rod portion 62 is disposed on one side of the first plate 61 and has a first rod hole 621 and a first sliding rod 622, and the first sliding rod 622 inserts through the first rod hole 621 and can be slidably disposed in the first curved slide grooves 34. The first outer arc-shaped slider 63 is disposed on the other side of the first plate 61 and spaced apart from the first sliding rod portion 62, and is slidably disposed on the first outer arc-shaped slideway 514, so that the first drop plate 6 can be pivotally carried on the first carrying member 51.

The second wing member 7 includes a second wing body 71, two second inner arc-shaped sliders 72, a second pivot portion 73, two second curved slide grooves 74 and a second through groove 75. The second wing body 71 is roughly bent in shape. The second inner arc-shaped sliders 72 are roughly semi-arc-shaped bodies, formed spaced apart from each other on one side of the second wing body 71 adjacent to the body portion 11, and are respectively and correspondingly slidably disposed on the second inner arc-shaped slideways 13, thereby the second wing member 7 can pivot relative to the body portion 11 with the second inner virtual axis V2 (FIG. 10) as the center. The second pivot portion 73 is disposed on one side of the second wing body 71 away from the body portion 11, and has a second pivot portion hole 731 extending along the second outer virtual axis V4 and a second pivot portion rod 732 passing through the second pivot portion hole 731. The second curved slide grooves 74 are spaced apart from each other and are respectively surrounded and defined by the second wing body 71, and are located between the second inner arc-shaped slider 72 and the second pivot portion 73, and have an L-shaped cross- section and a second head end 741 and a second tail end 742 opposite to the second head end 741 (FIG. 10). The second through groove 75 is formed through the second wing body 71 and is located between the second inner arc-shaped sliders 72 and the second pivot portion 73, and is located between the second curved slide grooves 74 and communicates with the second curved slide grooves 74.

The second transmission member 8 includes a second driving cam 81, a second bending plate 82 and a second straight slider 83. The second driving cam 81 is an end cam and has three second main convex portions 811, three second main concave portions 812, a second main through hole 813 and two second protrusions 814. The second main convex portions 811 extend outward along the second axis X2 and are spaced apart from each other, and the second main concave portions 812 are respectively formed between any two of the second main convex portions 811 and are spaced apart from each other. The second main through hole 813 is formed through the second axis X2 and is used for the second shaft 22 to insert through. The second protrusions 814 are spaced apart from each other and extend outward along the second axis X2 and face away from the second main convex portions 811. The second bending plate 82 is bent and extends outward along the radial direction of the second axis X2 from the second driving cam 81. The second straight slider 83 extends outward along the radial direction of the second axis X2 from the second bending plate 82, that is, two sides of the second bending plate 82 are respectively connected to the second driving cam 81 and the second straight slider 83.

The second panel body 9 includes a second carrying member 91 and a second panel housing 92. The second carrying member 91 has a second carrying body 911, a second pivoting joint 912, a second straight slide groove 913 and a second outer arc-shaped slideway 914. The second pivoting joint 912 extends outward from the second carrying body 911 and is pivotally connected to the second pivot portion rod 732 of the second pivot portion 73, and the second pivoting joint 912 and the second pivot portion 73 jointly define the second outer virtual axis V4 (FIG. 10), thereby the second carrying member 91 can rotate relative to the second wing member 7 about the second outer virtual axis V4. The second straight slide groove 913 is surrounded and defined by the second carrying body 911, extends roughly perpendicular to the second axis X2, and is used for the second straight slider 83 to slide linearly, thereby the second carrying member 91 can move linearly relative to the second transmission member 8. The second outer arc-shaped slideway 914 is formed on the second carrying body 911 and spaced apart from the second pivoting joint 912. The second panel housing 92, roughly in the shape of quadrilateral, is fixed to the second carrying member 91. In addition, the second panel body 9 further includes electronic components, but they are irrelevant to the folding operation and will not be described again.

The second drop plate A includes a second plate A1, a second sliding rod portion A2 and a second outer arc-shaped slider A3. The second plate Al is roughly rectangular in shape. The second sliding rod portion A2 is disposed on one side of the second plate Al and has a second rod hole A21 and a second sliding rod A22, and the second sliding rod A22 inserts through the second rod hole A21 and can be slidably disposed in the second curved slide grooves 74. The second outer arc-shaped slider A3 is disposed on the other side of the second plate Al and spaced apart from the second sliding rod portion A2, and is slidably disposed on the second outer arc-shaped slideway 914, so that the second drop plate A can be pivotally carried on the second carrying member 91.

The synchronization module B includes a first main gear B 1, a second main gear B2, a first auxiliary gear B3 and a second auxiliary gear B4. The first main gear B1 has a first gear body B 11, a first through hole B 12 and two first fixing blocks B 13. The first gear body B 11 is in the shape of a gear. The first through hole B 12 penetrates through the first gear body B 11 along the first axis X1, and the first shaft 21 inserts through the first through hole B12. The first fixing blocks B13 extend outward from one end surface of the first gear body B 11 at intervals, and are clamped between the first protrusions 414 of the first driving cam 41, so that the first main gear B 1 is fixedly connected to the first transmission member 4 and moves together with the first transmission member 4, and is located between the first transmission member 4 and the body portion 11. The second main gear B2 has a second gear body B21, a second through hole B22 and two second fixing blocks B23. The second gear body B21 is in the shape of a gear. The second through hole B22 penetrates through the second gear body B21 along the second axis X2, and the second shaft 22 inserts through the second through hole B22. The second fixing blocks B23 extend outward from one end surface of the second gear body B21 at intervals, and are clamped between the second protrusions 814 of the second driving cam 81, so that the second main gear B2 is fixedly connected to the second transmission member 8 and moves together with the second transmission member 8, and is located between the second transmission member 8 and the body portion 11 and spaced apart from the first main gear B1. The first auxiliary gear B3 has two first positioning tenons B31 extending outward in a direction parallel to the first axis X1 and opposite to each other, and one of the first positioning tenons B31 is pivotally connected to one of the concave holes 111. The second auxiliary gear B4 has two second positioning tenons B41 extending outward in a direction parallel to the second axis X2 and opposite to each other, and one of the second positioning tenons B41 is pivotally connected to the other one of the concave holes 111. The first auxiliary gear B3 and the second auxiliary gear B4 are meshed with each other and are located between the first main gear B 1 and the second main gear B2, and can be reversely rotatably connected to the body portion 11. The first auxiliary gear B3 is reversely rotatably engaged with the first main second main gear B2, the first auxiliary gear B3 and the second auxiliary gear B4.

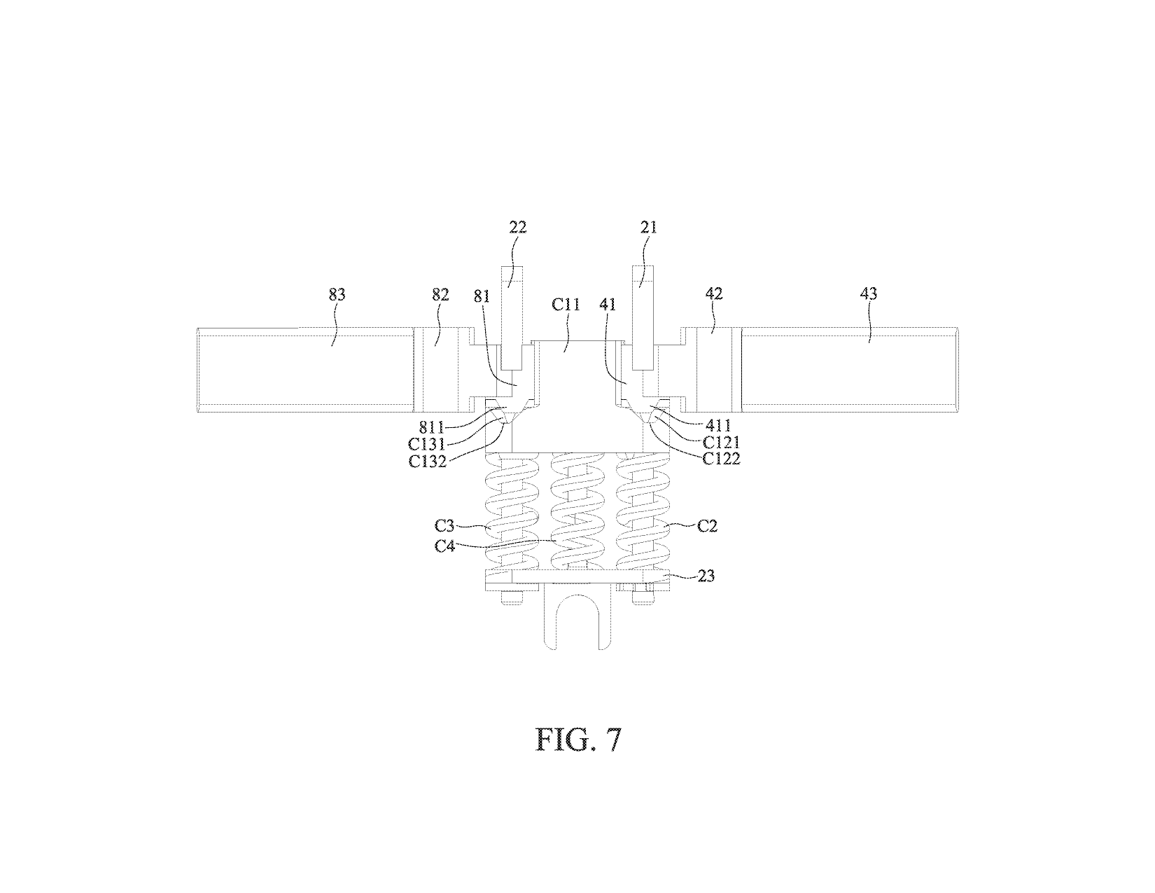

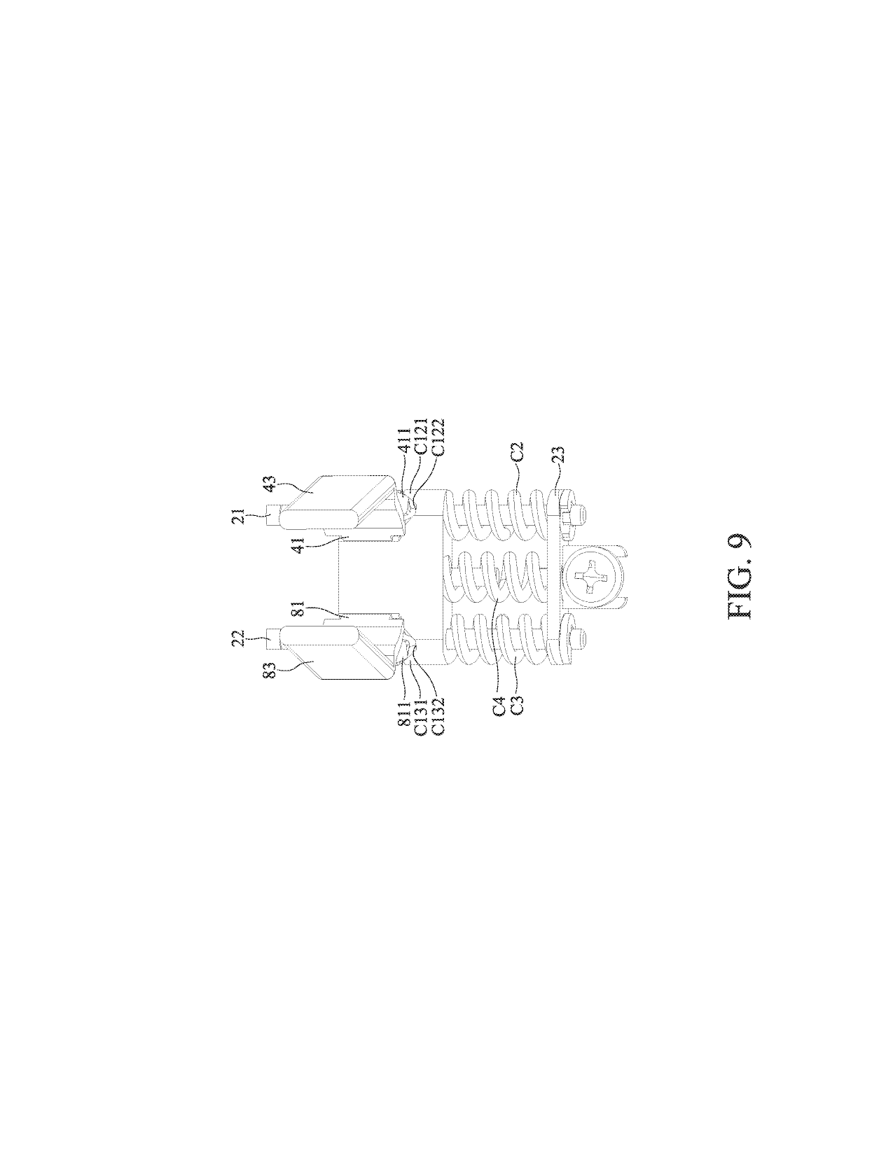

The elastic module C includes a pushing member C1, a first elastic member C2, a second elastic member C3 and a third elastic member C4, each of which is a compression spring in the embodiment. The pushing member C1 can be slidably sleeved on the first shaft 21 and the second shaft 22, and has a pushing body C11, a first driven cam C12, a second driven cam C13, a positioning elongate column C14 and two recessed holes C15. The pushing body C11 is roughly in the shape of a rectangular body. The first driven cam C12 is an end cam extending outward from one of the opposite sides of the pushing body C11, and is movably matched and engaged with the first driving cam 41 (FIG. 7 to FIG. 9), and has three first slave convex portions C121, three first slave concave portions C122 and a first slave through hole C123. The first slave convex portions C121 extend outward along the first axis X1 and are spaced apart from each other, and the first slave concave portions C122 are respectively formed between any two of the first slave convex portions C121 and are spaced apart from each other. The first slave through hole C123 is formed through the first axis X1 for the first shaft 21 to insert through, the cross-sectional area of the first slave through hole C123 is larger than the cross-sectional area of the first shaft 21, and the first slave through hole C123 has a circular cross-section, thereby the first driven cam C12 can slide on the first shaft 21 along the first axis X1 but does not move together. The second driven cam C13 is an end cam extending outward from the other one of the opposite sides of the pushing body C11, and is movably matched and engaged with the second driving cam 81 (FIG. 7 to FIG. 9), and has three second slave convex portions C131, three second slave concave portions C132 and a second slave through hole C133. The second slave convex portions C131 extend outward along the second axis X2 and are spaced apart from each other, and the second slave concave portions C132 are respectively formed between any two of the second slave convex portions C131 and are spaced apart from each other. The second slave through hole C133 is formed through the second axis X2 for the second shaft 22 to insert through, the cross-sectional area of the second slave through hole C133 is larger than the cross-sectional area of the second shaft 22, and the second slave through hole C133 has a circular cross-section, thereby the second driven cam C13 can slide on the second shaft 22 along the second axis X2 but does not move together. The positioning elongate column C14 extends outward from the rear side of the pushing body C11 along a direction parallel to the first axis X1 or the second axis X2. The recessed holes C15 are formed by being recessed from the front side of the pushing body C11 at intervals, and the other one of the first positioning tenons B31 and the other one of the second positioning tenons B41 are pivotally connected to the recessed holes C15 respectively. The first elastic member C2 is sleeved on the first shaft 21, and two ends of the first elastic member C2 abut against the first wing portion 232 and the first driven cam C12 respectively. The second elastic member C3 is sleeved on the second shaft 22, and two ends of the second elastic member C3 abut against the second wing portion 233 and the second driven cam C13 respectively. The third elastic member C4 is sleeved on the positioning short column 234 and the positioning elongate column C14 and is located between the first elastic member C2 and the second elastic member C3, and two ends of the third elastic member C4 abut against the fixed base 23 and the pushing member C1 respectively.

The flexible screen D is disposed on the first panel body 5, the first drop plate 6, the second panel body 9, the second drop plate A and the central base 1, and the flexible screen D includes a bendable area D1, a first small bending area D2 and a second small bending area D3. The bendable area D1 roughly corresponds to the central base 1, the first wing member 3, the first drop plate 6, the second wing member 7 and the second drop plate A. The first small bending area D2 roughly corresponds to the junction of the first carrying member 51 and the first drop plate 6. The second small bending area D3 roughly corresponds to the junction of the second carrying member 91 and the second drop plate A.

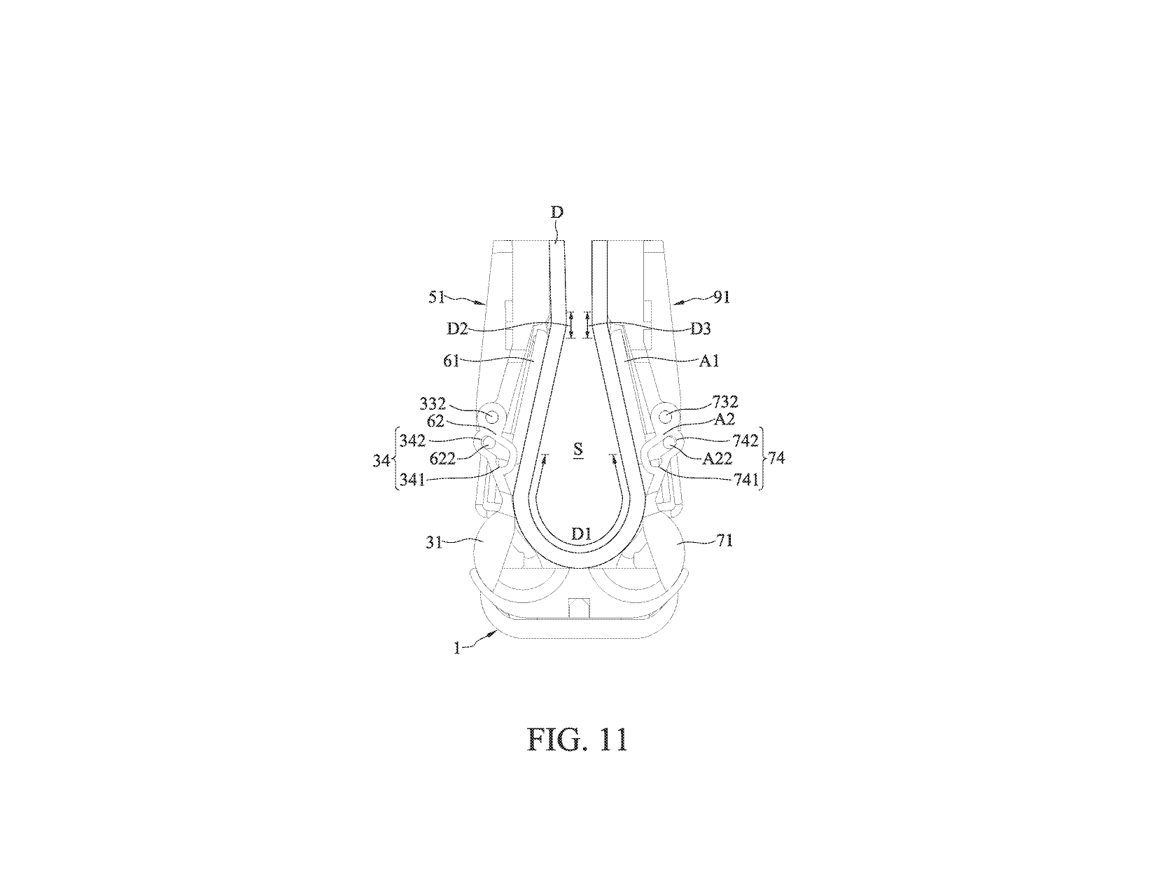

The following describes the operation of the foldable electronic device 1000 of the present disclosure. The first panel body 5 and the second panel body 9 can be changed between an unfolded state (FIG. 10) and a folded state (FIG. 11). When in the unfolded state, the flexible screen D is flattened, the first drop plate 6, the second drop plate A and the central base 1 jointly support the bendable area D1, and the first drop plate 6 and the second drop plate A are in contact with the top side of the housing 14. As shown in (only the pivot module 2, the first transmission member 4, the second transmission member 8 and the elastic module C are shown), at this time, the first driving cam 41 and the first driven cam C12 are matched and engaged with each other, that is, each of the first main convex portions 411 respectively extends into each of the first slave concave portions C122, and one side surface of each of the first main convex portions 411 partially contacts and generates friction with one side surface of each of the first slave convex portions C121, and the total length of the first driving cam 41 and the first driven cam C12 on the first axis X1 is minimized, and the second driving cam 81 and the second driven cam C13 are matched and engaged with each other, that is, each of the second main convex portions 811 respectively extends into each of the second slave concave portions C132, and one side surface of each of the second main convex portions 811 partially contacts and generates friction with one side surface of each of the second slave convex portions C131, and the total length of the second driving cam 81 and the second driven cam C13 on the second axis X2 is minimized, and the first elastic member C2, the second elastic member C3 and the third elastic member C4 are correspondingly released (that is, the amount of compression is minimum). Meanwhile, as shown in , the first sliding rod 622 of the first sliding rod portion 62 abuts against or is adjacent to the first head end 341 of the first curved slide groove 34, and the second sliding rod A22 of the second sliding rod portion A2 abuts against or is adjacent to the second head end 741 of the second curved slide groove 74.

When the first panel body 5 and the second panel body 9 are changed from the unfolded state to the folded state, the first wing member 3 and the second wing member 7 pivot relative to the body portion 11 with the first inner virtual axis V1 and the second inner virtual axis V2 respectively as the center and gradually move closer to each other (i.e., from the state that the first drop plate 6 and the second drop plate A are coplanar, gradually become the state that the first drop plate 6 and the second drop plate A are oblique to each other). At this time, the first carrying member 51 and the second carrying member 91 pivot and move relative to the first wing member 3 and the second wing member 7 respectively with the first outer virtual axis V3 and the second outer virtual axis V4 as the center, and the first straight slider 43 and the second straight slider 83 linearly slide in the first straight slide groove 513 and the second straight slide groove 913 respectively (gradually slide away from the first straight slide groove 513 and the second straight slide groove 913). At the same time, the first driving cam 41 and the first bending plate 42 pivot around the first axis X1 as the center, and the second driving cam 81 and the second bending plate 82 pivot around the second axis X2 as the center. Since the first main gear B 1 is fixedly connected to the first driving cam 41 and move together, and the second main gear B2 is fixedly connected to the second driving cam 81 and move together, the first auxiliary gear B3 and the second auxiliary gear B4 are respectively engaged with the first main gear B 1 and the second main gear B2 and can drive the first transmission member 4 and the second transmission member 8 to rotate synchronously and reversely. At the same time, the first sliding rod 622 can slide in the first curved slide groove 34, and the second sliding rod A22 can slide in the second curved slide groove 74.

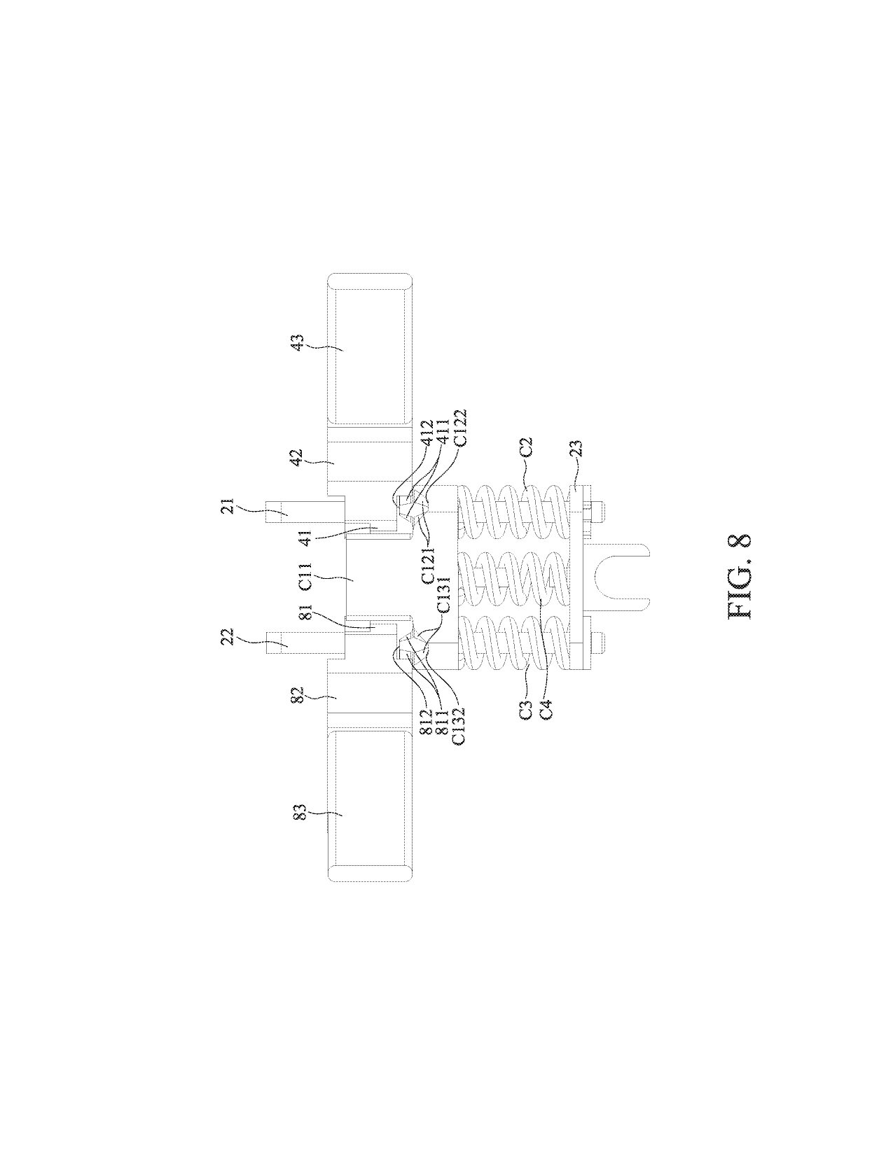

When the first panel body 5 and the second panel body 9 are changed from the unfolded state to the folded state, the first driving cam 41 gradually pushes away the first driven cam C12, and the second driving cam 81 gradually pushes away the second driven cam C13, so that the first elastic member C2, the second elastic member C3 and the third elastic member C4 are gradually compressed (the compression amount gradually becomes larger). When the first panel body 5 and the second panel body 9 are changed to the half- folded state between the unfolded state and the folded state, as show in FIG. 8 (only the pivot module 2, the first transmission member 4, the second transmission member 8 and the elastic module C are shown), the first driving cam 41 and the second driving cam 81 are in an abutting state with the first driven cam C12 and the second driven cam C 13 respectively, that is, each of the first main convex portions 411 respectively corresponds to and abuts against each of the first slave convex portions C121, each of the first main concave portions 412 respectively corresponds to each of the first slave concave portions C122, each of the second main convex portions 811 respectively corresponds to and abuts against each of the second slave convex portions C131, each of the second main concave portions 812 respectively corresponds to each of the second slave concave portions C132, the pushing member C1 moves to the fixed base 23 along the first shaft 21 and the second shaft 22, thereby compressing the first elastic member C2, the second elastic member C3 and the third elastic member C4 (that is, the compression amount is maximized). At this time, the total length of the first driving cam 41 and the first driven cam C12 on the first axis X1 is maximized, and the total length of the second driving cam 81 and the second driven cam C13 on the second axis X2 is maximized.

As the first panel body 5 and the second panel body 9 continue changing toward extends into each of the first slave concave portions C122 again, and one side surface of each of the first main convex portions 411 partially contacts (on the other side) and generates friction with one side surface of each of the first slave convex portions C121, and the second driving cam 81 and the second driven cam C13 are gradually matched and engaged with each other, that is, each of the second main convex portions 811 respectively extends into each of the second slave concave portions C132 again, and one side surface of each of the second main convex portions 811 partially contacts (on the other side) and generates friction with one side surface of each of the second slave convex portions C131, causing that the first elastic member C2, the second elastic member C3 and the third elastic member C4 are gradually released (that is, the compression amount gradually becomes smaller). As shown in FIG. 11at the same time, the first sliding rod 622 of the first sliding rod portion 62 abuts against or is adjacent to the first tail end 342 of the first curved slide groove 34, and the second sliding rod A22 of the second sliding rod portion A2 abuts against or is adjacent to the second tail end 742 of the second curved slide groove 74.

As shown in FIG. 11, when changing to the folded state, the total length of the first driving cam 41 and the first driven cam C12 on the first axis X1 is minimized, the total length of the second driving cam 81 and the second driven cam C13 on the second axis X2 is minimized, and the first elastic member C2, the second elastic member C3 and the third elastic member C4 are released (that is, the compression amount is minimized). The first drop plate 6 and the second drop plate A are away from the top side of the housing 14, at this time, the first drop plate 6 and the second drop plate A are respectively oblique to the body portion 11, the bendable area D1 of the flexible screen D is bent, the first drop plate 6, the second drop plate A and the central base 1 jointly define an accommodating space S to accommodate the bendable area D1, and the bendable area D1 is roughly semicircular. At this time, the first small bending area D2 and the second small bending area D3 are also slightly bent, so that the bendable area D1, the first small bending area D2 and the second small bending area D3 are roughly in the shape of a water drop.

In other embodiments, the pivot module 2, the first transmission member 4, the second transmission member 8, the synchronization module B and the elastic module C can be arranged in two sets, which are arranged on opposite sides of the central base 1 in a mirror-symmetrical manner (the number of other corresponding components is also relatively increased), that is, a single first carrying member 51, a single first drop plate 6, a single second carrying member 91 and a single second drop plate A can simultaneously connect to the two sets of pivot modules 2, first transmission members 4, second transmission members 8, synchronization modules B and elastic modules C, but the present disclosure is not limited to as such.

In view of the above, in the foldable electronic device of the present disclosure, the first wing member and the second wing member can pivot relative to the central base, the first carrying member and the second carrying member can pivot relative to the first wing member and the second wing member respectively, the first transmission member and the second transmission member are driven to slide linearly relative to the first carrying member and the second carrying member respectively, and the first transmission member and the second transmission member rotate synchronously and reversely through the synchronization module, so that when the first panel body and the second panel body are in the unfolded state, the first drop plate, the second drop plate and the central base jointly support the bendable area of the flexible screen, when the first panel body and the second panel body are in the folded state, the first drop plate, the second drop plate and the central base jointly define an accommodating space to accommodate the bendable area, so as to effectively create a large enough accommodating space to accommodate the bendable area without increasing the overall thickness.

What is claimed is:

1. A foldable electronic device, comprising:
a central base including a body portion, at least one first inner arc-shaped slideway and at least one second inner arc-shaped slideway, wherein the first inner arc-shaped slideway and the second inner arc-shaped slideway are formed on the body portion and spaced apart from each other;
a pivot module disposed on the central base and including a first shaft and a second shaft connected to the body portion, wherein the first shaft extends along a first axis, and the second shaft extends along a second axis;
a first wing member including at least one first inner arc-shaped slider and one first pivot portion, the first inner arc-shaped slider slidably disposed on the first inner arc-shaped slideway, wherein the first wing member is able to pivot relative to the body portion with a first inner virtual axis as a center;
a first transmission member sleeved on the first shaft;
a first panel body including a first carrying member, the first carrying member having a first pivoting joint and a first straight slide groove, wherein the first pivoting joint pivotally connected to the first pivot portion and jointly defined a first outer virtual axis, so that the first carrying member is able to rotate relative to the first wing member about tthe first outer virtual axis, and wherein the first transmission member is slidably disposed on the first straight slide groove, so that the first carrying member is able to linearly slide relative to the first transmission member;
a first drop plate pivotally carried on the first carrying member and slidably connected to the first wing member;
a second wing member including at least one second inner arc-shaped slider and one second pivot portion, the second inner arc-shaped slider slidably disposed on the second inner arc-shaped slideway, wherein the second wing member is able to pivot relative to the body portion with a second inner virtual axis as a center;
a second transmission member sleeved on the second shaft;
a second panel body including a second carrying member, the second carrying member having a second pivoting joint and a second straight slide groove, wherein the second pivoting joint pivotally connected to the second pivot portion and jointly defined a second outer virtual axis, so that the second carrying member is able to rotate relative to the second wing member about the second outer virtual axis, and wherein the second transmission member is slidably disposed on the second straight slide groove, and the second carrying member is able to linearly slide relative to the second transmission member;
a second drop plate pivotally carried on the second carrying member and slidably connected to the second wing member;
a synchronization module connected to the first transmission member and the second transmission member, and able to drive the first transmission member and the second transmission member to rotate synchronously and reversely;
an elastic module including a pushing member, wherein the pushing member is slidably sleeved on the first shaft and the second shaft, and movably engaged with the first ttransmission member and the second transmission member; and
a flexible screen disposed on the first panel body, the second panel body, the first drop plate, the second drop plate and the central base, and including a bendable area,wherein the first panel body and the second panel body are able to change between an unfolded state and a folded state, wherein when the first panel body and the second panel body are in the unfolded state, the flexible screen is flattened, and the first drop plate, the second drop plate and the central base jointly support the bendable area, and wherein when the first panel body and the second panel body are in the folded state, the bendable area of the flexible screen is bent, and the first drop plate, the second drop plate and the central base jointly define an accommodating space to accommodate the bendable area.

2. The foldable electronic device of claim 1, wherein the first drop plate includes a first sliding rod portion, the first wing member further includes at least one first curved slide groove, and the first curved slide groove is located between the first inner arc-shaped slider and the first pivot portion for the first sliding rod portion to be slidably disposed therein, and wherein the second drop plate includes a second sliding rod portion, the second wing member further includes at least one second curved slide groove, and the second curved slide groove is located between the second inner arc-shaped slider and the second pivot portion for the second sliding rod portion to be slidably disposed therein.

3. The foldable electronic device of claim 2, wherein the synchronization module
includes a first main gear, a second main gear, a first auxiliary gear and a second auxiliary gear, and wherein the first main gear is fixedly connected to the first transmission member and moves together with the first transmission member, the second main gear is fixedly connected to the second transmission member and moves together with the second transmission member, the first auxiliary gear and the second auxiliary gear are reversely rotatably connected to the body portion and meshed with each other, the first auxiliary gear is reversely rotatably engaged with the first main gear, and the second auxiliary gear is reversely rotatably engaged with the second main gear.

4. The foldable electronic device of claim 3, wherein the first transmission member includes a first driving cam, the second transmission member includes a second driving cam, the pushing member has a first driven cam and a second driven cam, the first driving cam is slidably sleeved on the first shaft along the first axis and fits with the first driven cam, the second driving cam is slidably sleeved on the second shaft along the second axis and fits with the second driven cam.

5. The foldable electronic device of claim 4, wherein the first curved slide groove has a first head end and a first tail end opposite each other, and the second curved slide groove has a second head end and a second tail end opposite each other, wherein when in the unfolded state, the first sliding rod portion abuts against the first head end, the second sliding rod portion abuts against the second head end, and wherein when in the folded state, the first sliding rod portion abuts against the first tail end, the second sliding rod portion abuts against the second tail end.

6. The foldable electronic device of claim 5, wherein the first curved slide groove and the second curved slide groove have a L-shaped cross section, respectively.

7. The foldable electronic device of claim 6, wherein the pivot module includes a fixed base, a first shaft hole and a second shaft hole, and the fixed base has a first wing portion and a second wing portion, wherein the first shaft hole is formed through the first wing portion along the first axis, and the first shaft inserts through the first shaft hole, and wherein the second shaft hole is formed through the second wing portion along the second axis, and the second shaft inserts through the second shaft hole.

8. The foldable electronic device of claim 7, wherein the first driven cam is sleeved on the first shaft, and the second driven cam is sleeved on the second shaft, wherein the elastic module further includes a first elastic member and a second elastic member respectively sleeved on the first shaft and the second shaft, two ends of the first elastic member respectively abut against the first wing portion and the first driven cam, and two ends of the second elastic member respectively abut against the second wing portion and the second driven cam, wherein when the first panel body and the second panel body are in a half- folded state between the unfolded state and the folded state, the first driving cam and the second driving cam abut against the first driven cam and the second driven cam, and the first elastic member and the second elastic member are compressed, and wherein when the first carrying member and the second carrying member are in the unfolded state or the folded state, the first elastic member and the second elastic member are released correspondingly.

9. The foldable electronic device of claim 8, wherein the elastic module further includes a third elastic member, the pushing member further has a positioning elongate column, the fixed base further has a positioning short column, the third elastic member is sleeved on the positioning elongate column and the positioning short column and respectively abuts against the pushing member and the fixed base, and the third elastic member is located between the first elastic member and the second elastic member.

10. The foldable electronic device of claim 9, wherein the first axis, the first inner virtual axis, the first outer virtual axis, the second axis, the second inner virtual axis and the second outer virtual axis are parallel to each other.

11. The foldable electronic device of claim 1, wherein the central base further includes a housing, the housing covers the body portion, when the first panel body and the second panel body are in the unfolded state, the first drop plate and the second drop plate contact a top side of the housing, when the first panel body and the second panel body are in the folded state, the first drop plate and the second drop plate are away from the housing.

12. The foldable electronic device of claim 11, wherein the first straight slide groove extends substantially perpendicular to the first axis, the first transmission member further includes a first bending plate and a first straight slider, the first bending plate bends and extends along a radial direction of the first axis, and the first straight slider extends outward from the first bending plate along the radial direction of the first axis and slides in the first straight slide groove, and wherein the second straight slide groove extends substantially perpendicular to the second axis, the second transmission member further includes a second bending plate and a second straight slider, the second bending plate bends and extends along a radial direction of the second axis, and the second straight slider extends outward from the second bending plate along the radial direction of the second axis and slides in the second straight slide groove.

13. The foldable electronic device of claim 12, wherein the first drop plate includes a first outer arc-shaped slider, and the first carrying member further has a first outer arc-shaped slideway, the first outer arc-shaped slider is slidably disposed on the first outer arc-shaped slideway, and wherein the second drop plate includes a second outer arc-shaped slider, the second carrying member further has a second outer arc-shaped slideway, and the second outer arc-shaped slider is slidably disposed on the second outer arc-shaped slideway.
